(19) United States
(12) Patent Application Publication
(10) Pub. No.: US 2024/0420489 A1
(43) Pub. Date: Dec. 19, 2024

(54) MEASURE IMAGE QUALITY OF BLOOD CELL IMAGES

(71) Applicant: Beckman Coulter, Inc., Brea, CA (US)

(72) Inventors: Bart J. WANDERS, Trabuco Canyon, CA (US); Jiuliu LU, Miami, FL (US); Bian QIAN, Weston, FL (US); John S. RILEY, Miami, FL (US)

(21) Appl. No.: 18/785,781

(22) Filed: Jul. 26, 2024

Related U.S. Application Data
(63) Continuation of application No. PCT/US23/11759, filed on Jan. 27, 2023.
(60) Provisional application No. 63/305,890, filed on Feb. 2, 2022.

(51) Int. Cl. G06V 20/69; G06T 5/30; G06T 7/00; G06T 7/194; G06V 10/60

(52) U.S. Cl. CPC G06V 20/695; G06T 5/30; G06T 7/0012; G06T 7/194; G06V 10/60; G06T 2207/30101

(57) ABSTRACT

A visual analysis system may be automatically focused (or the focus of such a system may be automatically corrected) by subjecting one or more images captured by such a system to a multi-layer analysis. In such an analysis, a cell boundary may be identified in an input image based on the lightness value of the pixels of the input image. Based on the identified cell boundary, a predicted nominal focus value is determined which can provide a focusing distance (e.g., a distance between the focal plane of a camera used when an image was captured and the actual focal plane for an in-focus image). This focusing distance may then be used to (re) focus a camera or for other purposes (e.g., generating an alert).

### CROSS REFERENCE TO RELATED APPLICATIONS

This claims priority from, and is a continuation of, international application PCT/US23/11759, entitled “Measure image quality of blood cell images”, filed Jan. 27, 2023 which itself claims priority from provisional patent application 63/305,890, entitled “Measure image quality of flow blood cell images” and filed in the U.S. patent and trademark office Feb. 2, 2022. Each of those applications is hereby incorporated by reference in its entirety.

### BACKGROUND

Blood cell analysis is one of the most commonly performed medical tests for providing an overview of a patient's health status. A blood sample can be drawn from a patient's body and stored in a test tube containing an anticoagulant to prevent clotting. A whole blood sample normally comprises three major classes of blood cells including red blood cells (erythrocytes), white blood cells (leukocytes) and platelets (thrombocytes). Each class can be further divided into subclasses of members. For example, five major types or subclasses of white blood cells (WBCs) have different shapes and functions. White blood cells may include neutrophils, lymphocytes, monocytes, eosinophils, and basophils. There are also subclasses of the red blood cell types. The appearances of particles in a sample may differ according to pathological conditions, cell maturity and other causes. Red blood cell subclasses may include reticulocytes and nucleated red blood cells.

This analysis may involve capturing images of a sample comprising blood cells, and the higher the quality of these images, the more suitable they are for analysis. However, capturing high quality images presents many problems. For example, ensuring that an image is in focus can be complicated by the fact that changes in temperature or other factors connected with the operation of an analyzer may cause an optics system that was previously in focus to require refocusing. Additionally, some types of focusing are not effective on all types of blood cells that may be found in a sample (e.g., a focusing method based on feature extraction may be suitable for red blood cells but not white blood cells). Accordingly, there is a need for improvements in the art related to the detection of out of focus images and/or automatic focusing of analyzer optics systems, including by providing fast and reliable methods for evaluating the quality of focusing and/or for automatically refocusing as needed.

### SUMMARY

Embodiments of the present disclosure may be used to determine a focus distance for a camera based on an image depicting one or more blood cells.

One embodiment may be to provide a system having a processor and an image capture device. Such a system may be configured to obtain a plurality of cell using the image capture device, each of the plurality of images containing at least one blood cell. Once captured, the system identifies a cell boundary within at least one image. Based on the cell boundary, the system can generate a plurality of rings, where each of the plurality of rings is offset from the cell boundary. Finally, the system can determine a predicted nominal focus value for the based on the lightness values of pixels disposed in the plurality of rings.

In a further embodiment, a method may exist in which a plurality of images are obtained from an image capture device. The plurality of images each containing an image of at least one blood cell. A cell boundary is then identified within at least one of the images. A plurality of rings are then generated based on the cell boundary, in which each of the plurality of rings is offset from the cell boundary. A predicted nominal focus value can then be determined for the at least one image based on the lightness values of the pixels disposed in the plurality of rings. Other embodiments are also disclosed.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a schematic illustration, partly in section and not to scale, showing operational aspects of an exemplary flowcell, autofocus system and high optical resolution imaging device for sample image analysis using digital image processing.

FIG. 2 illustrates a slide-based vision inspection system in accordance with an embodiment.

FIG. 3 illustrates a process which may be used to refocus an imaging device in accordance with an embodiment.

FIG. 4A illustrates an example image of a blood cell that is “positively” out of focus in accordance with an embodiment.

FIG. 4B illustrates an example image of a blood cell that is in focus in accordance with an embodiment.

FIG. 4C illustrates an example image of a blood cell that is “negatively” out of focus in accordance with an embodiment.

FIG. 5 illustrates a flowchart showing a method which could be used in an architecture associated with an embodiment.

FIG. 6A illustrates the identification of the approximate cell boundary in accordance with an embodiment.

FIG. 6B illustrates the placement of rings on the blood cell image in accordance with an embodiment.

FIG. 7 illustrates a graphical representation of the average lightness values of rings on the blood cell image in accordance with an embodiment.

FIG. 8 illustrates a graphical representation of the average lightness values of rings on variously focused blood cell images in accordance with an embodiment.

FIG. 9 illustrates a detailed view of a graphical representation of the average lightness values of rings on a blood cell image in accordance with an embodiment.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, and methods for analyzing a blood sample containing blood cells. In one embodiment, the disclosed technology may be used in the context of an automated imaging system which comprises an analyzer which may be, for example, a visual analyzer. In some embodiments, the visual analyzer may further comprise a processor to facilitate automated conversion and/or analysis of the images.

According to some aspects of this disclosure, a system comprising a visual analyzer may be provided for obtaining images of a sample comprising particles (e.g., blood cells) suspended in a liquid. Such a system may be useful, for example, in characterizing particles in biological fluids, such as detecting and quantifying erythrocytes, reticulocytes, nucleated red blood cells, platelets, and white blood cells, including white blood cell differential counting, categorization and subcategorization and analysis. Other similar uses such as characterizing blood cells from other fluids are also contemplated.

The discrimination of blood cells in a blood sample is an exemplary application for which the subject matter is particularly well suited, though other types of body fluid samples may be used. For example, aspects of the disclosed technology may be used in analysis of a non-blood body fluid sample comprising blood cells (e.g., white blood cells and/or red blood cells), such as serum, bone marrow, lavage fluid, effusions, exudates, cerebrospinal fluid, pleural fluid, peritoneal fluid, and amniotic fluid. It is also possible that the sample can be a solid tissue sample, e.g., a biopsy sample that has been treated to produce a cell suspension. The sample may also be a suspension obtained from treating a fecal sample. A sample may also be a laboratory or production line sample comprising particles, such as a cell culture sample. The term sample may be used to refer to a sample obtained from a patient or laboratory or any fraction, portion or aliquot thereof. The sample can be diluted, divided into portions, or stained in some processes.

In some aspects, samples are presented, imaged and analyzed in an automated manner. In the case of blood samples, the sample may be substantially diluted with a suitable diluent or saline solution, which reduces the extent to which the view of some cells might be hidden by other cells in an undiluted or less-diluted sample. The cells can be treated with agents that enhance the contrast of some cell aspects, for example using permeabilizing agents to render cell membranes permeable, and histological stains to adhere in and to reveal features, such as granules and the nucleus. In some cases, it may be desirable to stain an aliquot of the sample for counting and characterizing particles which include reticulocytes, nucleated red blood cells, and platelets, and for white blood cell differential, characterization and analysis. In other cases, samples containing red blood cells may be diluted before introduction to the flow cell and/or imaging in the flow cell or otherwise.

The particulars of sample preparation apparatus and methods for sample dilution, permeabilizing and histological staining, generally may be accomplished using precision pumps and valves operated by one or more programmable controllers. Examples can be found in patents such as U.S. Pat. No. 7,319,907. Likewise, techniques for distinguishing among certain cell categories and/or subcategories by their attributes such as relative size and color can be found in U.S. Pat. No. 5,436,978 in connection with white blood cells. The disclosures of these patents are hereby incorporated by reference in their entirety.

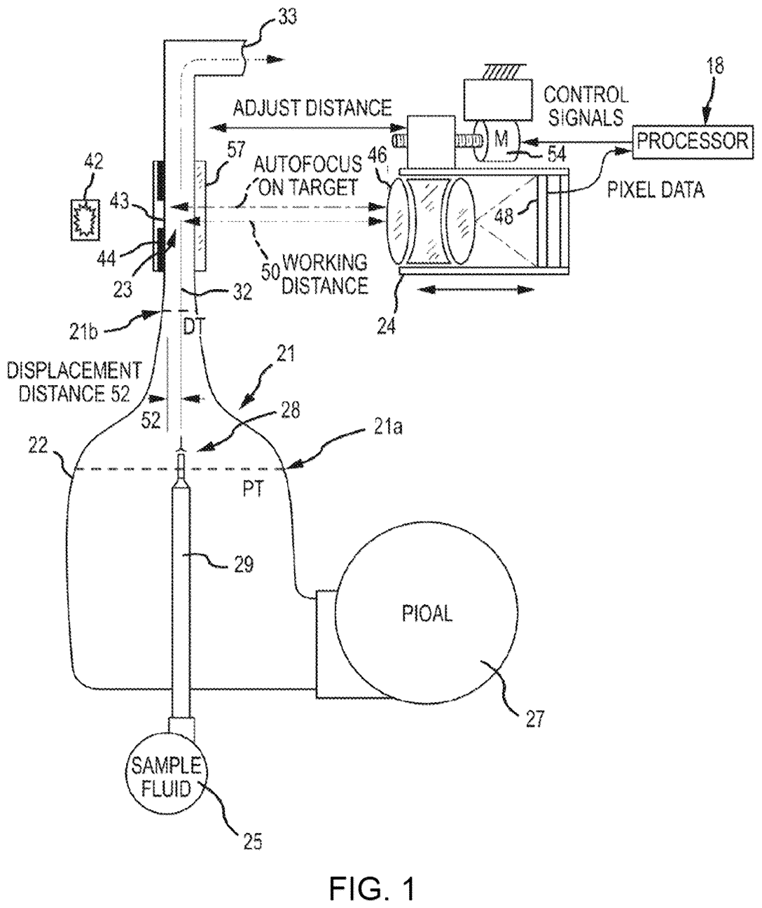

Turning now to the drawings, FIG. 1 schematically shows an exemplary flowcell 22 for conveying a sample fluid through a viewing zone 23 of a high optical resolution imaging device 24 in a configuration for imaging microscopic particles in a sample flow stream 32 using digital image processing. Flowcell 22 is coupled to a source 25 of sample fluid which may have been subjected to processing, such as contact with a particle contrast agent composition and heating. Flowcell 22 is also coupled to one or more sources 27 of a particle and/or intracellular organelle alignment liquid (PIOAL), such as a clear glycerol solution having a viscosity that is greater than the viscosity of the sample fluid, an example of which is disclosed in U.S. Pat. Nos. 9,316,635 and 10,451,612, the disclosures of which are hereby incorporated by reference in their entirety.

The sample fluid is injected through a flattened opening at a distal end 28 of a sample feed tube 29, and into the interior of the flowcell 22 at a point where the PIOAL flow has been substantially established resulting in a stable and symmetric laminar flow of the PIOAL above and below (or on opposing sides of) the ribbon-shaped sample stream. The sample and PIOAL streams may be supplied by precision metering pumps that move the PIOAL with the injected sample fluid along a flowpath that narrows substantially. The PIOAL envelopes and compresses the sample fluid in the zone 21 where the flowpath narrows. Hence, the decrease in flowpath thickness at zone 21 can contribute to a geometric focusing of the sample flow stream 32. The sample flow stream 32 is enveloped and carried along with the PIOAL downstream of the narrowing zone 21, passing in front of, or otherwise through the viewing zone 23 of, the high optical resolution imaging device 24 where images are collected, for example, using a CCD 48. Processor 18 can receive, as input, pixel data from CCD 48. The sample fluid ribbon flows together with the PIOAL to a discharge 33.

As shown here, the narrowing zone 21 can have a proximal flowpath portion 21a having a proximal thickness PT and a distal flowpath portion 21b having a distal thickness DT, such that distal thickness DT is less than proximal thickness PT. The sample fluid can therefore be injected through the distal end 28 of sample tube 29 at a location that is distal to the proximal portion 21a and proximal to the distal portion 21b. Hence, the sample fluid can enter the PIOAL envelope as the PIOAL stream is compressed by the zone 21, wherein the sample fluid injection tube has a distal exit port through which sample fluid is injected into flowing sheath fluid, the distal exit port bounded by the decrease in flowpath size of the flowcell.

The digital high optical resolution imaging device 24 with objective lens 46 is directed along an optical axis that intersects the ribbon-shaped sample flow stream 32. The relative distance between the objective 46 and the flowcell 33 is variable by operation of a motor drive 54, for resolving and collecting a focused digitized image on a photosensor array. Additional information regarding the construction and operation of an exemplary flowcell such as shown in FIG. 1 is provided in U.S. Pat. No. 9,322,752, entitled “Flowcell Systems and Methods for Particle Analysis in Blood Samples,” filed on Mar. 17, 2014, the disclosure of which is hereby incorporated by reference in its entirety.

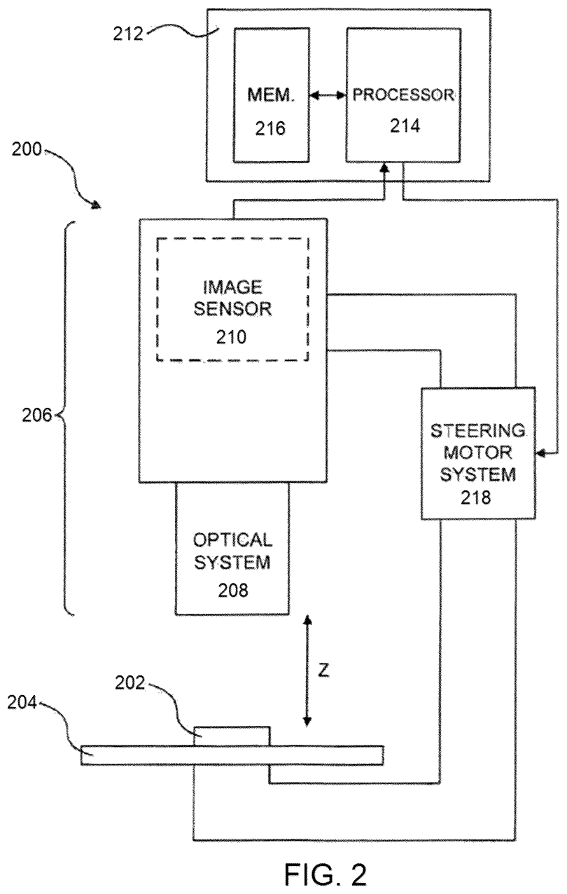

Aspects of the disclosed technology may also be applied in contexts other than flowcell systems such as shown in FIG. 1. For example, FIG. 2 illustrates a slide-based vision inspection system 200 in which aspects of the disclosed technology may be used. In the system shown in FIG. 2, a slide 202 comprising a sample, such as a blood sample, is placed in a slide holder 204. The slide holder 204 may be adapted to hold a number of slides or only one, as illustrated in FIG. 2. An image capturing device 206, comprising an optical system 208 and an image sensor 210, is adapted to capture image data depicting the sample in the slide 202. Further, in order to control the light environment and hence get image data, which is easier to analyze, a light emitting device (not shown) may be used.

The image data captured by the image capturing device 206 can be transferred to an image processing device 212. The image processing device 212 may be an external apparatus, such as a personal computer, connected to the image capturing device 206. Alternatively, the image processing device 212 may be incorporated in the image capturing device 206. The image processing device 212 can comprise a processor 214, associated with a memory 216, configured to determine changes needed to determine differences between the actual focus and a correct focus for the image capturing device 206. When the difference is determined an instruction can be transferred to a steering motor system 218. The steering motor system 218 can, based upon the instruction from the image processing device 212, alter the distance z between the slide 202 and the optical system 208.

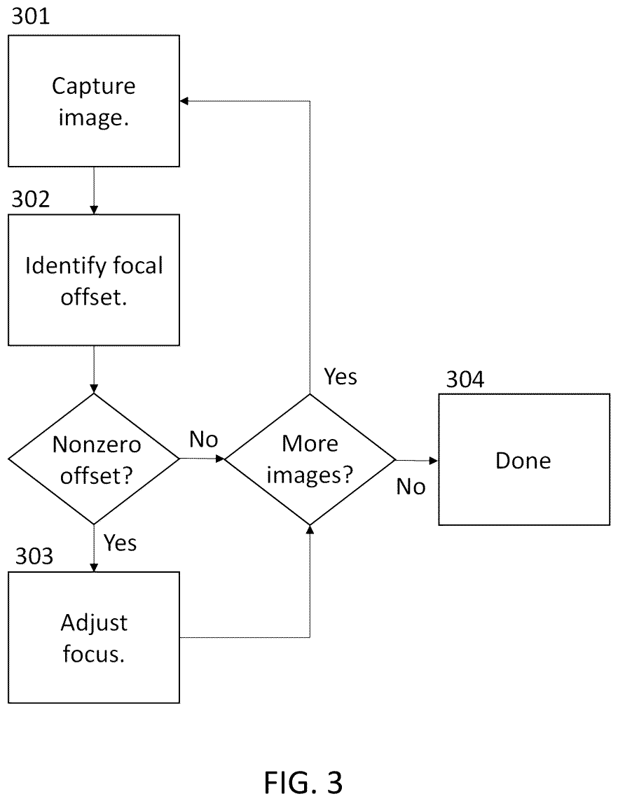

In a system such as shown in FIG. 1 or FIG. 2, components such as motor drive 54 or steering motor system 218 may be used in a process such as shown in FIG. 3 to continuously refocus imaging devices (e.g., digital high optical resolution imaging device 24 or image capturing device 206) to maximize the quality of images produced for subsequent analysis. In a process such as shown in FIG. 3, when an image is captured 301, it may be analyzed 302 to identify an offset between the expected focusing plane (i.e., the plane on which the imaging device was focused when it was captured) and the correct focusing plane (i.e., the plane on which the imaging device would need to have been focused to capture an in-focus image). In the event that the offset was zero (i.e., the plane on which the imaging device was focused when the image was captured was the correct focusing plane), the process may continue with capturing images until all of the images needed for analysis had been captured. Alternatively, if the offset was not zero (e.g., if there was a 2 μm separation between the expected and correct focusing planes), then the imaging device's focusing plane could be adjusted 303 to account for the offset. For instance, if the correct focusing plane was 2 μm below the expected focusing plane, then a component such as the motor drive 54 or steering motor system 218 may be used to move the imaging device 2 μm closer to the sample, or to move the sample (e.g., by moving the flowcell holding the sample) 2 μm closer to the imaging device, so that the expected and correct focusing planes would be the same for the next image. This process could then be repeated performed until the image capturing was complete 304, thereby ensuring that any deviations caused by factors such as temperature changes would be detected and addressed.

As would be understood by one of ordinary skill in the art, a typical human white blood cell (WBC) can be considered as a sphere when it is recorded by the optics of a flow imaging device and is captured as a two-dimensional (2D) circular cell image with internal structure. Alternatively, a typical human red blood cell (RBC) is a biconcave disk, approximately 0.8-1 μm thick in the disk center and 2-2.5 μm thick at the rim, and when viewed in the correct focus, the brightness contrast between the center part and the rim is reduced. Thus, creating a system that can capture and analyze the different physical characteristics of both RBC and WBC is a difficult challenge.

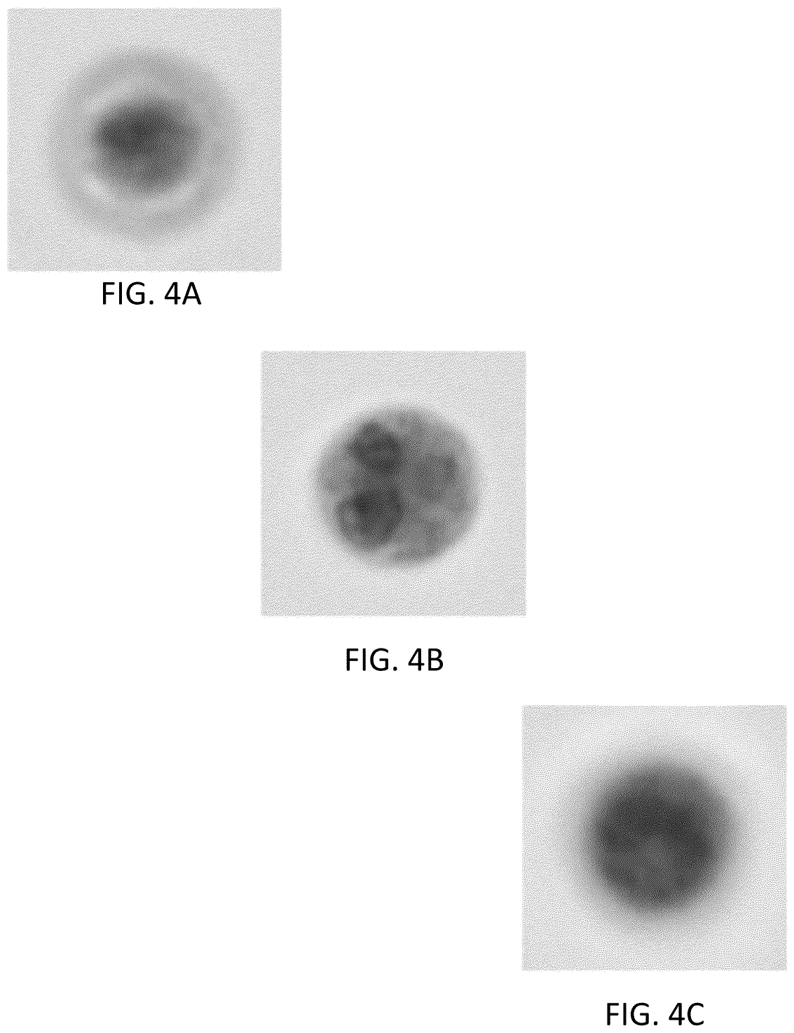

One of the major hurdles to evaluating a WBC image is that WBC's have various nucleus and granules in its cell boundary, which can complicate the application of image pattern recognition. Referring briefly to FIGS. 4A-4C, when a WBC is captured in-focus, its image contains relatively sharp boundaries and fine details of the interior of the cell, such as shown in FIG. 4B. However, if the system were to capture out of focus images (e.g., FIGS. 4A and 4C) the boundaries may be blurred, and the internal structure of the cell may be indistinguishable. Moreover, the unknown nature of the internal structure creates complications for automatic image analysis (e.g., determining if an image is in or out of focus) because the system does not have a standard WBC template.

In order to overcome these issues, the system and/or method disclosed herein may rely on the interactions of the illumination device and WBCs. For example, in some embodiments, the illumination device may generate various “halo” patterns around the cell boundary as the focusing quality varies (see FIGS. 4A-4C). These “halo” patterns are independent of internal structure of the WBCs, and thus may be used during image processing (i.e., as discussed herein) to evaluate images of any/all WBC sub-types, such as, for example, Neutrophils, Monocytes, Lymphocyte, etc. More specifically, in some embodiments, the “halo” pattern(s) may be characterized with, and analyzed using, a ring-based feature extraction process. This feature extraction process may involve analyzing the images in a specific color space (e.g., a color space with a lightness value).

Solely for illustrative purpose, the majority of this disclosure and the examples therein focus on the HSV and/or HSL color space. However, it should be understood that these are non-limiting examples and that other color spaces could be used, such as, for example, HSV, HSL, the Munsell color system, LCh, NCS, CIELCHᵤᵥ, CIELCH_{ab}, CIECAM02, or any current or future color space that evaluates lightness level/value. It should also be understood that although the system/method discussed herein relies primarily on a lightness level, it may be possible, in some embodiments, to use color spaces that do not have a lightness factor. For example, in some embodiments, the system may utilize/combine the characteristics of an RGB color space to provide information similar/equivalent to a lightness level.

As discussed herein, the system captures images over time, such as using the image capture device 24 of FIG. 1. If/when images are captured out of focus, they are either “positively” or “negatively” out of focus depending on if the image capture device is too close or too far. For example, FIG. 4A represents an out of focus image that is “positively” focused meaning the image capture device is too close to the cell compared to an ideal position, while FIG. 4C represents an out of focus image that is “negatively” focused meaning the image capture device is too far from the cell compared to an ideal position.

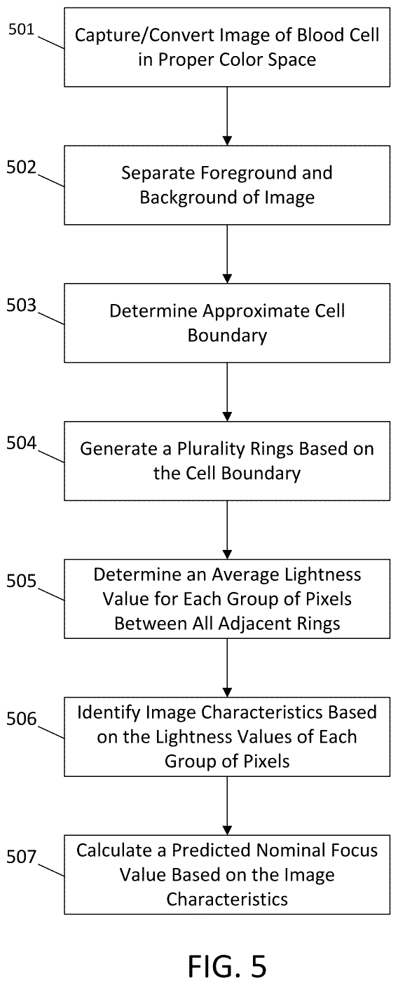

Referring now to FIG. 5, an illustrative example process for measuring the image quality of flow blood cell images is shown. As stated above, before any image analysis is performed, the images may be placed in a color space which facilitates extraction of a lightness value. Thus, in some embodiments, the image capture device may be a specialized image capture device capable of capturing images in the proper color space 501. Additionally, or alternatively, the system may convert any images captured by the image capture device to the proper color space prior to analyzing 501. Regardless of the method used, once an image is in the proper color space, the system may separate the image's foreground from its background 502, such as by evaluating a lightness value from the image (e.g., V in HSV or L in HSL). As discussed herein, because of the “halo” effect (shown in FIGS. 4A, 4B, and 4C) determining where the cell (i.e., foreground) ends and the biological fluids (i.e., background) begins is possible even when the WBC or RBC is out of focus.

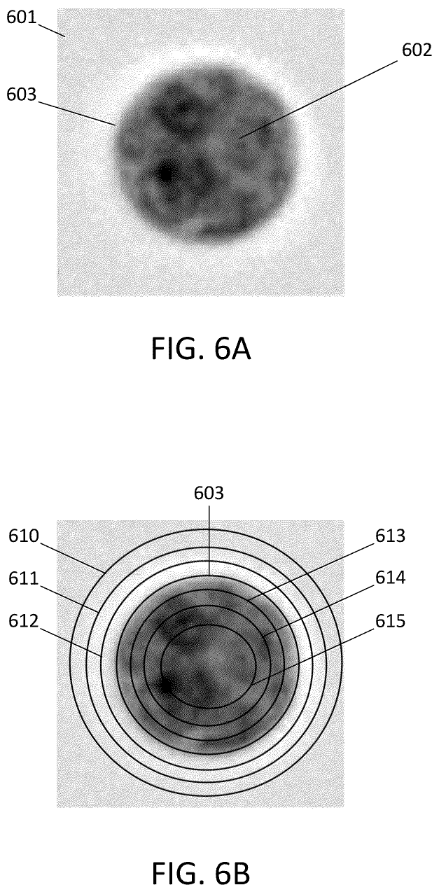

More specifically, in order to separate the foreground from the background of the image 502, the system may evaluate each pixel of the captured image against a threshold lightness value (e.g., V=204). Referring briefly to FIG. 6A, in some embodiments, if the pixel is above the threshold value, it is defined as foreground 602, while any pixels below the threshold value are defined as background 601. In some embodiments, the threshold value may be product specific, stated differently, two systems may have different threshold values based on factors in their design. For example, the two products may have different illumination devices or different image capture devices, and thus, the images captured by those systems may require different threshold values.

Accordingly, in some embodiments, the lightness value threshold may be determined/identified during the product design or manufacturing via machine learning/training with human oversight. In an alternative embodiment, the system may automatically (i.e., without human oversight) determine the lightness threshold using one or more known image analysis techniques. Such as, for example, creating a histogram of lightness values and determining the most accurate lightness value or lightness value range that is associated with the most significant lightness transition.

In a further embodiment, the system may evaluate the pixels starting at the center point of the image and then expand outwardly. Thus, because the image to be analyzed should contain a singular cell 501 (e.g., because it was captured as a single cell image, or extracted from an image of multiple cells), beginning the evaluation at the center may reduce the number of pixels that must be analyzed. Stated differently, once the system determines the entire cell boundary 603, it can move forward without the need to analyze the remaining exterior of the image. It should be understood that various other edge detection or foreground segmentation methods may be used to separate the two 502. In some embodiments, the interface, or intersection, of the background 601 and foreground 602 of the captured image is defined as cell boundary 603. Thus, as discussed herein, the system may create and/or overlay a virtual cell boundary within the image based on the determined foreground and background 503.

Once the approximate cell boundary 603 is determined 503, a plurality of rings may be generated and offset from the cell boundary 504. Thus, in some embodiments, and as shown in FIG. 6B, once the system has determined 503 the cell boundary 603, a plurality of rings (e.g., 610, 611, 612, 613, 614, and 615) may be generated 504. It should be understood that rings 610, 611, 612, 613, 614, and 615 are for illustrative purpose only and should not be considered the only rings identified/created by the system. Thus, although only 6 total rings are shown, in some alternative embodiments, there may be many more rings (e.g., 7, 8, 9, 10, 50, 100, 1,000, 10,000, 100,000, etc.). In other embodiments, fewer rings can be used (e.g., 2 to 5 rings).

As shown in FIG. 6B, the system may utilize rings that are 1-level, 2-levels, 3-levels, etc. smaller than the cell boundary (e.g., 613, 614, and 615 respectively) as well as rings that are 1-level, 2-levels, 3-levels, etc. larger than the cell boundary (e.g., 612, 611, and 610 respectively). In some embodiments, the location and/or size of the rings is based on the approximate cell boundary 603. For example, one method of creating/identifying one or more smaller rings is to apply morphological image erosion from the cell boundary. Alternatively, creating/identifying one or more larger rings may involve applying morphological image dilation from the cell boundary. In yet another embodiment, the system may fit the cell boundary with an approximate ellipse. The approximate ellipse is then enlarged and/or reduced to generate the rings. In a further embodiment, the enlarging and reducing of the approximate ellipse may be based on an offset distance or factor. For example, the approximate ellipse may be expanded based on a unit of measurement (e.g., 1 μm, 0.1 μm, etc.) or a pixel value (e.g., 1 pixel, 5 pixels, 10 pixels etc.).

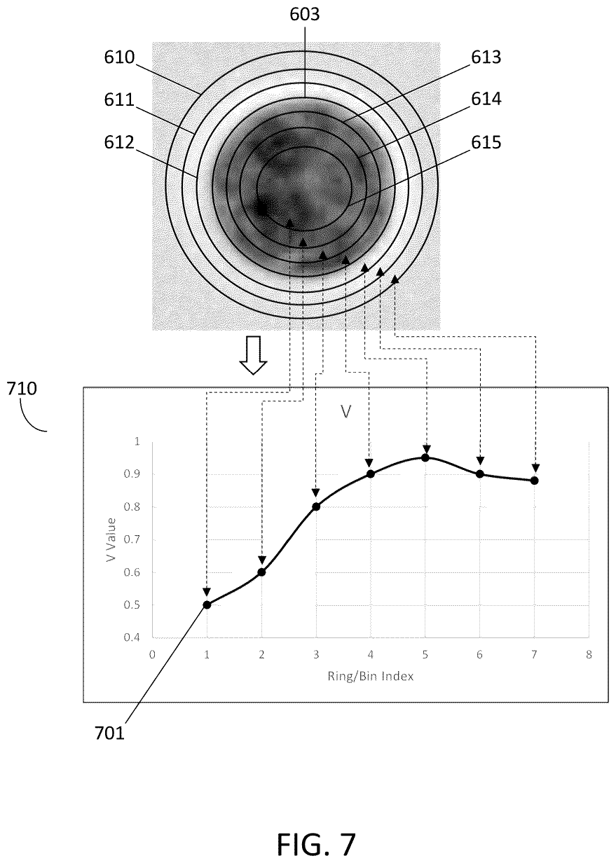

Returning to FIG. 5, once the plurality of rings are generated around the cell boundary 504, the system then determines an average lightness value for each group of pixels between all adjacent rings 505. Specifically, the system determines 505 an average lightness value of all the pixels captured between two rings. For example, all the lightness values of the pixels between rings 610 and 611 would be averaged to determine 505 a single average lightness value for the area between 610/611 (i.e., bin index 7 of FIG. 7). Similar calculations would be performed for the areas between ring 611 and ring 612, ring 612 and the ring boundary 603, the ring boundary 603 and ring 513, ring 613 and 614, and ring 614 and 615.

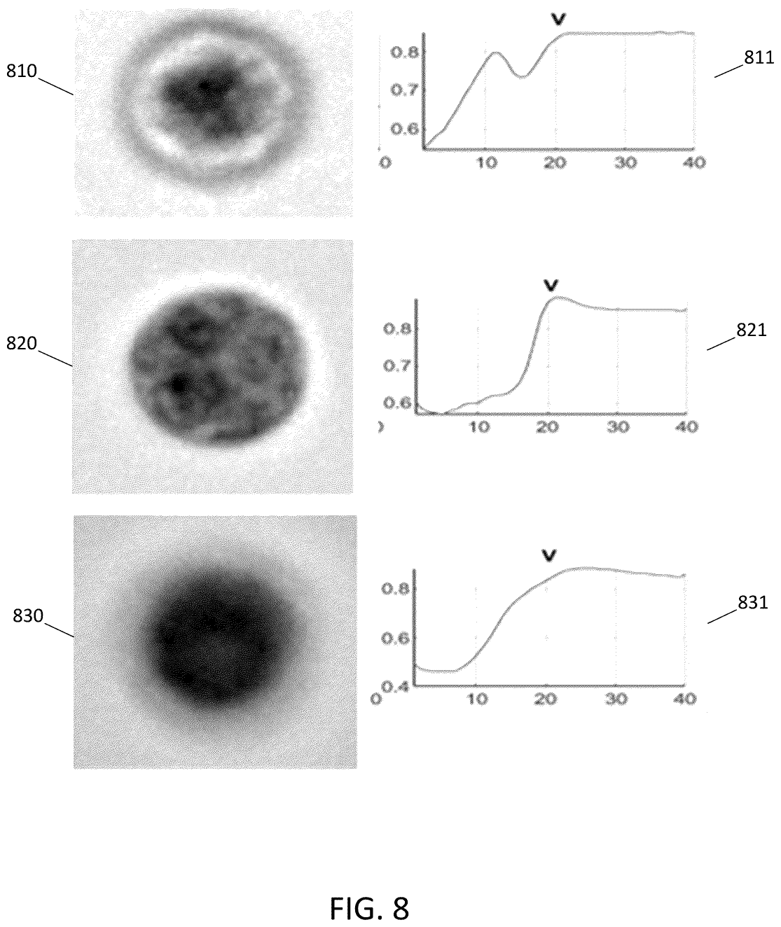

Once all the average lightness values have been calculated for each pair of adjacent rings 505, the system identifies various image characteristics based on the average lightness values 506. In some embodiments, and as shown in FIG. 7, the system may plot (e.g., in a Cartesian coordinate system) the average lightness value vs the bin indexes. It should be understood that although the instant disclosure discusses and shows various plots/graphs, they are for illustrative purposes only. Thus, as would be understood by one of ordinary skill in the art, in practice such plots/graphs may not be generated, and instead a function or other numerical representation that relates index to lightness may be created and analyzed using the disclosed techniques without. Stated differently, the disclosed systems and/or methods may or may not provide any kind of externally visible plot such as those shown in FIGS. 7-8.

By way of non-limiting example, FIG. 7 illustrates an embodiment in which the area inside the smallest circle (i.e., ring 615) is assigned bin index value 1 and has a determined lightness value (i.e., V-value) of approximately 0.5. The determined average lightness value is then placed in the plot and associated with bin index 1 at 701. In a further embodiment, and as shown, the remaining areas (e.g., that area between ring 611 and ring 612, ring 612 and the ring boundary 603, the ring boundary 603 and ring 613, ring 613 and 614, and ring 614 and 615) are added to the plot at their respective values. By plotting the bin index on the X-axis and the corresponding lightness value on the Y-axis, a lightness curve is created 710. In an alternative embodiment, the system may plot the bin index on the Y-axis and the corresponding lightness value of the X-axis. Furthermore, in some embodiments, the values on the X axis may increase from the outside rather than from the inside.

Referring now to FIG. 8, three cell images are shown (i.e., 810, 820 and 830) alongside their respective graphical plots (i.e., 811, 821, and 831). As shown, image 810 represents an out-of-focus image in the positive direction (i.e., “positively focused” whereby the image capture device is too close to the cell compared to an ideal position), image 820 represents an in-focus image, and image 830 represents an out-of-focus image in the negative direction (i.e., “negatively focused” whereby the image capture device is too far to the cell compared to an ideal position). Thus, in some embodiments, and as shown, when the lightness value is plotted as a function of the bin index, distinct lightness curves are created for each level of focus.

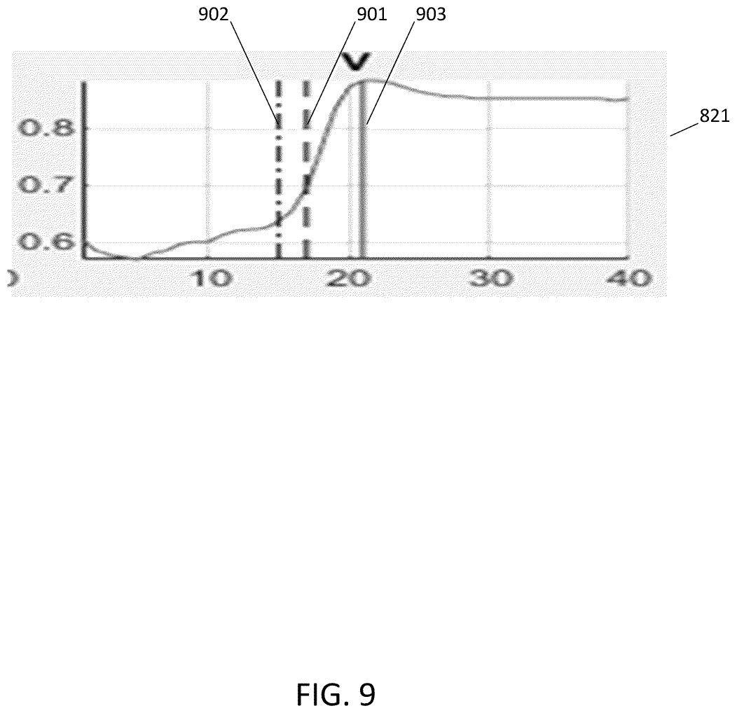

Accordingly, in some embodiments, the system can analyze the function of each curve (e.g., 811, 821, and 831) to determine if an image is out of focus, and if so, by how much and in what direction (i.e., positively or negatively). Accordingly, the system may identify various image characteristics (e.g., an inflection point, a left mark, and a right mark) based on the function/curve of the average lightness value as compared to the bin index numbers 506. By way of non-limiting example, FIG. 9 shows an enlarged representation of plot 821 (i.e., the graphical plot of the in-focus image 820).

In some embodiments, and as shown in FIG. 9, an inflection point 901 may be identified/determined as the point with the fastest change in the V-value (i.e., lightness value), which may be calculated by taking the 1^{st} order derivative of the V-curve. In a further embodiment, a left mark 902 may be identified/determined as a valley to the left of the inflection point. In an alternative embodiment, or in cases where no valley is found to the left of the inflection point, the left mark may be calculated as the peak of the 2^{nd} order derivative of the V-curve to the left of the inflection point 901. In another embodiment, a right mark 903 may be identified/determined as a peak to the right of the inflection point. In an alternative embodiment, or if no peak is found to the right of the inflection point, the right mark may be calculated by taking the 2^{nd} order derivative of the V-curve to the right of the inflection point 901.

In some embodiments, once the inflection point 901, left mark 902 and right mark 903 are determined, the system may then calculate several numeric features. More specifically, the system may calculate:
a. an “Inflection_right_mark_distance,” which is equal to the distance between the inflection point 901 and right mark 902 on the V curve;
b. a “Left_right_mark_distance,” which is equal to the distance between the left and right marks on the V curve;
c. a “V_right_mark_value,” which is equal to the V value of the right mark; and
d. a “V_left_mark_value,” which is equal to the V value of the left mark.

Once the characteristics are identified 506 and/or the numerical features are calculated, the system may, in some embodiments, calculate a predicted nominal focus value 507. By way of non-limiting example, if the determined nominal focus is equal to 0.0 μm, it can be assumed that the imaging device is at the perfect focusing position (i.e., the system is in-focus). Alternatively, when focusing quality deteriorates and nominal focus moves away from 0.0 μm either in positive or negative direction. The system may use the above four numeric features (i.e., the inflection_right_mark_distance, the left_right_mark_distance, the V_right_mark_value, and the V_left_mark_value) to correlate with the nominal focus and measure the focusing quality. Stated differently, the system may use the above numerical features to predict the nominal focus.

In some embodiments, the system may mathematically define a function with the numerical features as inputs and the predicted nominal focus as output in the following format: Predicted Nominal Focus f (inflection_right_mark_distance, lef_right_mark_distance, V_right_mark_value, V_left_mark_value). The particular processing which this type of function may use to provide its outputs may vary from case to case. For example, it may be defined using neural networks, support vector machines, polynomial regression, linear regression, etc. By way of non-limiting example, the system may use a 2^{nd}-order polynomial regression defined as below:

$$Predicted Nominal Focus = - 6.8694 e - 01 * inflection\_right \_mark \_distance + 7.164 e - 02 * left\_right \_mark \_distance + - 9.857 e + 02 * V\_right \_mark \_value + 1.6144 e + 01 * V\_left \_mark \_value + 2.9647 e - 02 * inflection\_right \_mark \_distance * inflection\_right \_mark \_distance + - 7.2789 e - 03 * left\_right \_mark \_distance * left\_right \_mark \_distance + 5.625 e + 02 * V\_right \_mark \_value * V\_right \_mark \_value + - 1.0997 e + 01 * V\_left \_mark \_value * V\_left \_mark \_value + 4.2827 e + 02$$

Other similar equations may also be used. For example, instead of using the precise values set forth in the above exemplary equation, a 2^{nd} order polynomial equation may be expressed in a form such as the following:

$${F}_{Predicted} = {LC}_{IRMD} * inflection\_right \_mark \_distance + {LC}_{LRMD} * left\_right \_mark \_distance + {LC}_{VRMV} * V\_right \_mark \_value + {LC}_{VLMV} * V\_left \_mark \_value + {SC}_{IRMD} * inflection\_right \_mark {\_distance}^{2} + {SC}_{LRMD} * left\_right \_mark {\_distance}^{2} + {SC}_{VRMV} * V\_right \_mark {\_value}^{2} + {SC}_{VLMV} * V\_left \_mark {\_value}^{2}$$

In the above exemplary equation, F_{Predicted} is the predicted nominal focus. LC_{IRMD} is a real number between −6.8*10⁻¹ and −6.9*10⁻¹. LC_{LRMD} is real number between 7.1*10⁻² and 7.2*10⁻². LC_{VRMV} is a real number between −9.8*10² and −9.9*10². LC_{VLMV} is a real number between 1.6*10¹ and 1.7*10¹. SC_{IRMD} is a real number between 2.9*10⁻² and 3.0*10⁻². SC_{LRMD} is a real number between 7.2*10⁻³ and 7.3*10⁻³. SC_{VRMV} is a real number between 5.6*10² and 5.7*10² and SC_{VLMY} is a real number between 4.2*10² and 4.3*10². Other equations and classes of equations could also be used, and so the above equations, whether expressed in terms of ranges or in terms of discrete values, should be understood as illustrative only, and should not be treated as limiting.

The information which could be used as a basis for deriving equations such as shown above, whether from polynomial regressions, neural networks or otherwise, could be obtained in a variety of manners. For example, ground truth images for training a system to generate predicted nominal focus values can be obtained through human annotation of images produced during normal operation of an analyzer (e.g., a human inspecting images and then labeling them with the difference, if any, between actual and optimal focal planes based on their own experience and training with identifying focused cell images and out of focused cell images), but they could also be acquired in other manners. For example, an analyzer can be used to capture images which are in focus, and images which are out of focus by known amounts by intentionally changing the relationship between the imaging and the sample(s) being imaged after the in focus images are captured.

Table 1 show examples of how an intentional offsetting of an ideal focal distance can be used as part of a training procedure. In various examples, a camera or camera lens is set at a first ideal focal position to capture an in focus blood cell. The camera or camera lens is then offset in either direction to establish a training set for out of focus data. For instance, a camera or camera lens may start at position X which correlates to an ideal focal quality position (e.g., offset zero). It may then be offset in both directions, for example between −1 to +1 microns in either direction, between −2 to +2 microns in either direction, between −3 to +3 microns in either direction, between −4 to +4 microns in either direction, or between −5 to +5 microns in either direction in fixed interval (e.g., intervals of 0.1 microns, 0.2 microns, 0.3 microns, 0.4 microns, or 0.5 microns). In the context of Table 1, X indicates the start position and n indicates the offset increment (e.g., 0.3 microns) defining the fixed intervals that the camera offsets in each sample run. Other approaches are also possible, such as moving in variable increments, moving in increments which are different for different directions (e.g., moving away from a flowcell in increments of 0.3 microns and moving closer to the flowcell in increments of 0.2 microns), obtaining images from different numbers of positions than shown in table 1 (e.g., moving to 6n closer to the flowcell and 4n away from the flowcell), etc. Different types of training data creation, such as providing sets of images to a human reviewer and asking him or her to specify an offset distance for each image, are also possible. Accordingly, the description of how intentional offsetting of an ideal focal distance can be used as part of a training procedure should be understood as being illustrative only, and should not be treated as implying limitations on the protection provided by this document or any related documents.

In some examples, this training step is performed for separate groupings of blood cells. For instance, Red Blood Cells in a first sample, and White Blood cells in another sample so that the system is trained to identify focal quality from smaller cells (e.g., red blood cells) and larger cells (e.g., White blood cells). The various types of cells used to train the system can include Red blood cells, Platelets, and various groupings of White blood cells (neutrophils, lymphocytes, monocytes, eosinophils, and basophils). In other examples, the system is solely trained on a particular cell type (e.g., only red blood cells, only white blood cells, or only specific types of white blood cells such as only Neutrophils).

TABLE 1

| Focal | |
|---|---|
| Position | Focal Position Description |
| X − 5n | 5 units out of focus too far away from flowcell |
| X − 4n | 4 units out of focus too far away from flowcell |
| X − 3n | 3 units out of focus too far away from flowcell |
| X − 2n | 2 units out of focus too far away from flowcell |
| X − n | 1 unit out of focus too far away from flowcell |
| X | Ideal focal position |
| X + n | 1 units out of focus too close to flowcell |
| X + 2n | 2 units out of focus too close to flowcell |
| X + 3n | 3 units out of focus too close to flowcell |
| X + 4n | 4 units out of focus too close to flowcell |
| X + 5n | 5 units out of focus too close to flowcell |

Accordingly, in some embodiments, the predicted nominal focus may be calculated for every single WBC image in a blood sample and hence the system can measure the focusing/image quality of every single WBC image. In a further embodiment, the predicted nominal focus can then be used in downstream components. By way of non-limiting example, the downstream component could be an image classification algorithm that can label WBC images based on their biological nature. Moreover, if the system determines that the focusing/image quality is poor on a single image, or across many images, the system can flag and/or invalidate the classification results. Indeed, the inventors contemplate that focus evaluation and/or auto focusing such as described herein may be used to improve image quality in any type of device which captures flow images of blood cells. It should also be understood that the disclosed systems and/or methods may utilize images captured as cells are presented through an imaging region (e.g., in a flowcell type system with an imaging device configured to take images of cells as they pass through an analysis region of the flowcell), which may be one by one or may include multiple cells being presented and captured in a single frame where a computing methodology is then used to isolate cell images on a per-cell basis. Accordingly, the above figures and their associated discussion should not be used to imply limitations on the scope of protection provided by this document or any other document that claims the benefit of, or is otherwise related to, this document.

In another embodiment, the predicted nominal focus may also be utilized at the sample level. Furthermore, the mean, median, percentile, and/or other mean-like statistics of the predicted nominal focus, of all or some of the WBC image may indicate whether a systematic shift in focusing took place during the imaging process. Moreover, the dispersion or spread of the predicted nominal focus of all or some of the WBC images may provide information associated with the flow stability during the image acquisition. Thus, as discussed above, various metrics associated with an image, or plurality of images, may be stored to enhance the usefulness of the images downstream.

In another embodiment, the system may automatically take proactive steps toward correcting the predicted nominal focus. For example, the system may perform an autofocusing process, whereby, the image capture device, or other component is adjusted to improve the nominal focus. For example, the system may adjust the location of the image capture device, based on the predicted nominal focus using mechanical parts. Thus, the predicted nominal focus value can serve as an indicator of focusing quality. Namely, when the absolute value of the nominal focus is closer to 0.0 μm, the focusing quality is better. In some embodiments, the sign of the predicted nominal focus value may indicate of the direction of out-of-focus system.

An architecture such as shown and discussed in the context of FIGS. 1-9 may be implemented in a variety of manners. For example, it is possible that such an architecture may be implemented as a convolutional neural network (CNN) to utilize a regression method for better measuring the focusing quality. In this type of implementation, the specific values used for analyzing images and generating outputs can be optimized by training the neural network using blood cell images having known focusing positions to minimize regression errors between known and calculated focusing positions.

Variations may also be possible in methods which may utilize focusing technology such as described herein. For example, an autofocusing process such as described herein may be implemented to run a series of samples to determine how a camera should be focused and adjust the focus on a run-by-run basis rather than on an image-by-image basis. Similarly, rather than automatically refocusing a camera, a focusing position may be used to generate an alert (e.g., if the difference between expected and correct focusing planes exceeds a threshold, or shows a trend that focus is drifting), after which point the user may decide whether to refocus the analyzer or continue with the then current imaging task. Automatic focusing such as described herein may also/alternatively be included in a periodic (e.g., daily) quality control process. Data gathered in automatic focusing may subsequently be used to improve the operation of a system. For example, if it is found that adjustments made during automatic focusing are consistently in one directly, this may be used as a diagnostic indicator that there are system imperfections in the analyzer's mechanical or optical components that, when fixed, may reduce the need for automatic refocusing. As another example of how automatic focusing as described herein may be applied, consider that, in some cases, even when focus is acceptable, different focusing positions within an acceptable range may result in different features being more or less clearly perceptible in the images. In such cases, focusing information may be used to characterize the images captured by the system (e.g., as being closer to, or farther from, the sample while within an acceptable range) so that downstream processing may be optimized as needed depending on what features are being detected (e.g., by applying a sharpening kernel if a particular feature may be more difficult to identify based on the characterization). Accordingly, the image by image autofocusing described previously should be understood as being illustrative only and should not be treated as implying limitations on the protection provided by this or any related document.

Variations are also possible in how a focusing method such as described herein may be implemented. For instance, in some cases a method such as shown in FIG. 5 may include additional steps to facilitate the processing and utilization of images. An example of such an additional step may be to pre-process or reformat an image before subjecting it to analysis. This may include, in an example where processing is performed using a CNN trained to take a certain type of image as input (e.g., 128×128×3 RGB images), resizing images and converting them to the proper color space to match the training inputs before subjecting them to analysis. Accordingly, as with the potential contexts and applications in which the disclosed technology may be used, the specific implementation may vary from case to case, and the examples, figures and descriptions set forth herein should be understood as non-limiting.

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A system comprising: a processor; an image capture device; and a non-transitory computer readable medium storing instructions that cause the processor to perform a set of acts comprising: obtaining, from the image capture device, a plurality of images, each of the plurality of images containing a blood cell; identifying a cell boundary within at least one image; generating, based on the cell boundary, a plurality of rings, each of the plurality of rings being offset from the cell boundary; and determining a predicted nominal focus value for the at least one image based on lightness values of pixels disposed in the plurality of rings.

### Example 2

The system of example 1, wherein determining the predicted nominal focus value for the at least one image is further based on lightness values of pixels disposed between every pair of adjacent rings in the plurality of rings.

### Example 3

The system of example 1, wherein obtaining a plurality of images further comprises converting each of the plurality of images to a color space having a lightness value.

### Example 4

The system of example 1, wherein identifying the cell boundary within the at least one image further comprises separating, based on a predetermined lightness value, the at least one image into a foreground and a background.

### Example 5

The system of example 1, wherein generating the plurality of rings further comprises at least one of: generating at least one larger ring using morphological dilation of the cell boundary, wherein additional larger rings are generated using morphological dilation on a previously generated larger ring; and generating at least one smaller ring using morphological erosion of the cell boundary, wherein additional smaller rings are generated using morphological erosion on a previously generated smaller ring.

### Example 6

The system of example 1, wherein generating the plurality of rings further comprises at least one of: identifying, based on the cell boundary, a best fit ellipse shape; and generating, based on an offset distance, at least one larger ring, wherein additional larger rings are generated, based on the offset distance, from a previously generated larger ring; and identifying, based on the cell boundary, a best fit ellipse shape; and generating, based on an offset distance, at least one smaller ring, wherein additional smaller rings are generated, based on the offset distance, from a previously generated smaller ring.

### Example 7

The system of example 1, wherein determining the predicted nominal focus value for the at least one image based on lightness values of pixels disposed in the plurality of rings further comprises identifying a plurality of characteristics based on the lightness values by performing acts comprising: generating a V-curve of the average lightness value associated with each area between two adjacent rings against the known distance of each of the plurality of rings from the cell boundary; identifying an inflection point on V-curve, wherein the inflection point is equal to a peak on the 1^{st} order derivative of the V-curve; identifying a left mark on the V-curve, wherein the left mark is equal to a peak of the 2^{nd} order derivative of the V-curve to the left of the inflection point; identifying a right mark on the V-curve, wherein the right mark is equal to a valley of the 2^{nd} order derivative of the V-curve to the right of the inflection point.

### Example 8

The system of example 7, wherein determining the predicted nominal focus value for the at least one image further comprises calculating a distance between the inflection point and the right mark, a distance between the left mark and the right mark, a V value for the right mark and a V value for the left mark, wherein the predicted nominal focus is a function of the distance between the inflection point and the right mark, the distance between the left mark and the right mark, the V value for the right mark, and the V value for the left mark.

### Example 9

The system of example 1, wherein the set of acts further comprise: invalidating the at least one image based on the predicted nominal focus value.

### Example 10

The system of example 1, wherein the set of acts further comprise: obtaining a plurality of predicted nominal focus values, wherein each nominal focus value corresponds to a different image within the plurality of images; determining a median of the plurality of predicted nominal focus values; and translating the image capture device based on the median of the plurality of the predicted nominal focus values.

### Example 11

The system of example 1, wherein the set of acts further comprise: obtaining a plurality of predicted nominal focus values, wherein each nominal focus value corresponds to a different image within the plurality of images; determining a median of the plurality of predicted nominal focus values; and evaluating, based on the median of the plurality of the predicted nominal focus values, a flow stability of a blood sample containing the blood cell.

### Example 12

A method comprising: obtaining, from an image capture device, a plurality of images, each of the plurality of images containing a blood cell; identifying a cell boundary within at least one image; generating, based on the cell boundary, a plurality of rings, each of the plurality of rings being offset from the cell boundary; and determining a predicted nominal focus value for the at least one image based on lightness values of pixels disposed in the plurality of rings.

### Example 13

The method of example 12, wherein determining the predicted nominal focus value for the at least one image is further based on lightness values of pixels disposed between every pair of adjacent rings in the plurality of rings.

### Example 14

The method of example 12, wherein identifying the cell boundary within the at least one image further comprises separating, based on a predetermined lightness value, the at least one image into a foreground and a background.

### Example 15

The method of example 12, wherein generating the plurality of rings further comprises at least one of: generating at least one larger ring using morphological dilation of the cell boundary, wherein additional larger rings are generated using morphological dilation on a previously generated larger ring; and generating at least one smaller ring using morphological erosion of the cell boundary, wherein additional smaller rings are generated using morphological erosion on a previously generated smaller ring.

### Example 16

The method of example 12, wherein generating the plurality of rings further comprises at least one of: identifying, based on the cell boundary, a best fit ellipse shape; and generating, based on an offset distance, at least one larger ring, wherein additional larger rings are generated, based on the offset distance, from a previously generated larger ring; and identifying, based on the cell boundary, a best fit ellipse shape; and generating, based on an offset distance, at least one smaller ring, wherein additional smaller rings are generated, based on the offset distance, from a previously generated smaller ring.

### Example 17

The method of example 12, wherein determining the predicted nominal focus value for the at least one image further based on lightness value of pixels disposed in the plurality of rings further comprises identifying a plurality of characteristics based on the lightness values by performing acts comprising: generating a V-curve of the average lightness value associated with each area between two adjacent rings against the known distance of each of the plurality of rings from the cell boundary; identifying an inflection point on V-curve, wherein the inflection point is equal to a peak on the 1^{st} order derivative of the V-curve; identifying a left mark on the V-curve, wherein the left mark is equal to a peak of the 2^{nd} order derivative of the V-curve to the left of the inflection point; identifying a right mark on the V-curve, wherein the right mark is equal to a valley of the 2^{nd} order derivative of the V-curve to the right of the inflection point.

### Example 18

The method of example 17, wherein determining the predicted nominal focus value for the at least one image further comprises calculating a distance between the inflection point and the right mark, a distance between the left mark and the right mark, a V value for the right mark and a V value for the left mark, wherein the predicted nominal focus is a function of the distance between the inflection point and the right mark, the distance between the left mark and the right mark, the V value for the right mark, and the V value for the left mark.

### Example 19

The method of example 12, further comprising: invalidating the at least one image based on the predicted nominal focus value.

### Example 20

The method of claim 12, further comprising: obtaining a plurality of predicted nominal focus values, wherein each nominal focus value corresponds to a different image within the plurality of images; determining a median of the plurality of predicted nominal focus values; and translating the image capture device based on the median of the plurality of the predicted nominal focus values.

### Example 21

The method of example 12, further comprising: obtaining a plurality of predicted nominal focus values, wherein each nominal focus value corresponds to a different image within the plurality of images; determining a median of the plurality of predicted nominal focus values; and evaluating, based on the median of the plurality of the predicted nominal focus values, a flow stability of a blood sample containing the blood cell.

### Example 22

A machine comprising: a camera; and a means for determining a focus distance for the camera based on an image depicting one or more blood cells.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general-purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and the claims, the phrase “means for determining a focus distance for the camera based on an image depicting one or more blood cells” is a means plus function limitations as provided for in 35 U.S.C. § 112 (f), in which the function is “determining a focus distance for the camera based on an image depicting one or more blood cells” and the corresponding structure is a computer configured to use an algorithm as illustrated in FIGS. 5-9 and described in the accompanying description.

It should be understood that, in the above examples and claims, the term “set” should be understood as one or more things which are grouped together.

What is claimed is:

1. A system comprising:
a processor;
an image capture device; and
a non-transitory computer readable medium storing instructions that cause the processor to perform a set of acts comprising:
obtaining, from the image capture device, a plurality of images, each of the plurality of images containing a blood cell;
identifying a cell boundary within at least one image;
generating, based on the cell boundary, a plurality of rings, each of the plurality of rings being offset from the cell boundary; and
determining a predicted nominal focus value for the at least one image based on lightness values of pixels disposed in the plurality of rings by identifying a plurality of image characteristics based on the lightness values.

2. The system of claim 1, wherein the blood cell is a white blood cell.

3. The system of claim 1, wherein identifying the cell boundary within the at least one image further comprises separating, based on a predetermined lightness value, the at least one image into a foreground and a background.

4. The system of claim 1, wherein generating the plurality of rings further comprises at least one of:
generating at least one larger ring using morphological dilation of the cell boundary, wherein additional larger rings are generated using morphological dilation on a previously generated larger ring; and
generating at least one smaller ring using morphological erosion of the cell boundary, wherein additional smaller rings are generated using morphological erosion on a previously generated smaller ring.

5. The system of claim 1, wherein generating the plurality of rings further comprises at least one of:
identifying, based on the cell boundary, a best fit ellipse shape; and generating, based on an offset distance, at least one larger ring, wherein additional larger rings are generated, based on the offset distance, from a previously generated larger ring; and
identifying, based on the cell boundary, a best fit ellipse shape; and generating, based on an offset distance, at least one smaller ring, wherein additional smaller rings are generated, based on the offset distance, from a previously generated smaller ring.

6. The system of claim 1, wherein identifying the plurality of characteristics based on the lightness values comprises:
generating a V-curve of the average lightness value associated with each area between two adjacent rings against the known distance of each of the plurality of rings from the cell boundary;
identifying an inflection point on V-curve, wherein the inflection point is equal to a peak on the 1st order derivative of the V-curve;
identifying a left mark on the V-curve, wherein the left mark is equal to a peak of the 2nd order derivative of the V-curve to the left of the inflection point; and
identifying a right mark on the V-curve, wherein the right mark is equal to a valley of the 2nd order derivative of the V-curve to the right of the inflection point.

7. The system of claim 6, wherein determining the predicted nominal focus value for the at least one image further comprises calculating a distance between the inflection point and the right mark, a distance between the left mark and the right mark, a V value for the right mark and a V value for the left mark, wherein the predicted nominal focus is a function of the distance between the inflection point and the right mark, the distance between the left mark and the right mark, the V value for the right mark, and the V value for the left mark.

8. The system of claim 1, wherein the set of acts further comprise: invalidating the at least one image based on the predicted nominal focus value.

9. The system of claim 1, wherein the set of acts further comprise:
obtaining a plurality of predicted nominal focus values, wherein each nominal focus value corresponds to a different image within the plurality of images; and
determining a median of the plurality of predicted nominal focus values; and translating the image capture device based on the median of the plurality of the predicted nominal focus values.

10. The system of claim 1, wherein the set of acts further comprise:
obtaining a plurality of predicted nominal focus values, wherein each nominal focus value corresponds to a different image within the plurality of images; and
determining a median of the plurality of predicted nominal focus values; and evaluating, based on the median of the plurality of the predicted nominal focus values, a flow stability of a blood sample containing the blood cell.

11. A method comprising:
obtaining, from an image capture device, a plurality of images, each of the plurality of images containing a blood cell;
identifying a cell boundary within at least one image;
generating, based on the cell boundary, a plurality of rings, each of the plurality of rings being offset from the cell boundary; and
determining a predicted nominal focus value for the at least one image based on lightness values of pixels disposed in the plurality of rings by identifying a plurality of image characteristics based on the lightness values.

12. The method of claim 11, wherein identifying the cell boundary within the at least one image further comprises separating, based on a predetermined lightness value, the at least one image into a foreground and a background.

13. The method of claim 11, wherein generating the plurality of rings further comprises at least one of:
generating at least one larger ring using morphological dilation of the cell boundary, wherein additional larger rings are generated using morphological dilation on a previously generated larger ring; and
generating at least one smaller ring using morphological erosion of the cell boundary, wherein additional smaller rings are generated using morphological erosion on a previously generated smaller ring.

14. The method of claim 11, wherein generating the plurality of rings further comprises at least one of:
identifying, based on the cell boundary, a best fit ellipse shape; and generating, based on an offset distance, at least one larger ring, wherein additional larger rings are generated, based on the offset distance, from a previously generated larger ring; and
identifying, based on the cell boundary, a best fit ellipse shape; and generating, based on an offset distance, at least one smaller ring, wherein additional smaller rings are generated, based on the offset distance, from a previously generated smaller ring.

15. The method of claim 11, wherein identifying the plurality of characteristics based on the lightness values comprises:
generating a V-curve of the average lightness value associated with each area between two adjacent rings against the known distance of each of the plurality of rings from the cell boundary;
identifying an inflection point on V-curve, wherein the inflection point is equal to a peak on the 1st order derivative of the V-curve;
identifying a left mark on the V-curve, wherein the left mark is equal to a peak of the 2nd order derivative of the V-curve to the left of the inflection point; and
identifying a right mark on the V-curve, wherein the right mark is equal to a valley of the 2nd order derivative of the V-curve to the right of the inflection point.

16. The method of claim 15, wherein determining the predicted nominal focus value for the at least one image further comprises calculating a distance between the inflection point and the right mark, a distance between the left mark and the right mark, a V value for the right mark and a V value for the left mark, wherein the predicted nominal focus is a function of the distance between the inflection point and the right mark, the distance between the left mark and the right mark, the V value for the right mark, and the V value for the left mark.

17. The method of claim 11, further comprising: invalidating the at least one image based on the predicted nominal focus value.

18. The method of claim 11, further comprising:
obtaining a plurality of predicted nominal focus values, wherein each nominal focus value corresponds to a different image within the plurality of images; and
determining a median of the plurality of predicted nominal focus values; and translating the image capture device based on the median of the plurality of the predicted nominal focus values.

19. The method of claim 11, further comprising:
obtaining a plurality of predicted nominal focus values, wherein each nominal focus value corresponds to a different image within the plurality of images; and
determining a median of the plurality of predicted nominal focus values; and evaluating, based on the median of the plurality of the predicted nominal focus values, a flow stability of a blood sample containing the blood cell.

20. The method of claim 11, wherein the blood cell is a white blood cell.
